(19) United States
(12) Patent Application Publication
(10) Pub. No.: US 2026/0064070 A1
(43) Pub. Date: Mar. 5, 2026

(54) CLEANING BLADE, PROCESS CARTRIDGE, AND IMAGE FORMING APPARATUS

(71) Applicant: KEIICHIRO JURI, TOKYO (JP)

(72) Inventor: KEIICHIRO JURI, TOKYO (JP)

(73) Assignee: Ricoh Company, Ltd., Tokyo (JP)

(21) Appl. No.: 19/262,626

(22) Filed: Jul. 8, 2025

(30) Foreign Application Priority Data
Sep. 4, 2024 (JP) 2024-152522

(51) Int. Cl. G03G 21/00; G03G 21/18

(52) U.S. Cl. CPC G03G 21/0017; G03G 21/1814

(57) ABSTRACT

A cleaning blade includes a blade substrate, a blade support, and a coating layer. The blade substrate includes an elastic body having a tip portion to be in contact with a surface of an object to clean the surface of the object. The blade support supports the blade substrate. The coating layer coats at least the tip portion of the elastic body to form a tip ridge in contact with the surface of the object. The coating layer has a developed interfacial area ratio (Sdr) of 1.2% or more and 1.8% or less in a 100 μm square region inward from the tip ridge of the coating layer on the blade substrate.

### CROSS-REFERENCE TO RELATED APPLICATIONS

This patent application is based on and claims priority pursuant to 35 U.S.C. § 119(a) to Japanese Patent Application No. 2024-152522, filed on Sep. 4, 2024, in the Japan Patent Office, the entire disclosure of which is hereby incorporated by reference herein.

### BACKGROUND

### Technical Field

The present disclosure relates to a cleaning blade, a process cartridge, and an image forming apparatus.

### Related Art

An electrophotographic image forming apparatus includes a cleaner to remove residual toner adhering to the surface of an image bearer (also referred to as a cleaning target or an object) from which a toner image has been transferred to a recording medium or an intermediate transfer body in an image forming process.

A cleaning blade is used in the cleaner because of its simple configuration and excellent cleaning performance. The cleaning blade typically includes an elastic body, made of polyurethane rubber, and a support. With a base end of the elastic body supported by the support, a contact part (i.e., a tip ridge) of the elastic body is pressed against a surface of the image bearer. Thus, residual toner particles remaining on the surface of the image bearer are dammed up and scraped off to be removed.

### SUMMARY

The present disclosure described herein provides the cleaning blade including a blade substrate, a blade support, and a coating layer. The blade substrate includes an elastic body having a tip portion to be in contact with a surface of an object to clean the surface of the object. The blade support supports the blade substrate. The coating layer coats at least the tip portion of the elastic body to form a tip ridge in contact with the surface of the object. The coating layer has a developed interfacial area ratio (Sdr) of 1.2% or more and 1.8% or less in a 100 μm square region inward from the tip ridge of the coating layer on the blade substrate.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic cross-sectional view of a cleaning blade in contact with a surface of an image bearer;

FIG. 2 is a perspective view of a cleaning blade to clean an image bearer;

FIG. 3 is a schematic cross-sectional view of another cleaning blade to clean an image bearer;

FIG. 4 is a schematic cross-sectional view of an image forming apparatus;

FIG. 5 is a schematic cross-sectional view of a process cartridge in the image forming apparatus of FIG. 4; and

FIG. 6 is a schematic diagram illustrating a method for forming a coating layer in examples.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

With reference to the drawings, descriptions are given below of embodiments of the present disclosure. In the drawings illustrating the following embodiments, like reference signs are allocated to elements having the same function or shape and redundant descriptions thereof are omitted below.

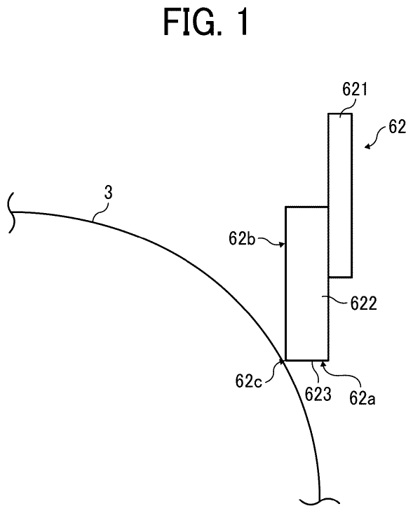

A cleaning blade according to an embodiment of the present disclosure is described below with reference to FIGS. 1 to 3. The applications of the cleaning blade are provided herein for the purpose of illustration only and are not intended to be limiting. Identical or similar reference signs are given to elements similar to those illustrated in each drawing, and redundant explanation may be omitted. The number, position, and shape of the members described below are not limited to those in the embodiments described below and can be suitably set to suit a particular application.

FIG. 1 is a schematic cross-sectional view of a cleaning blade 62. The cleaning blade 62 includes a cleaning blade support 621 and a cleaning blade substrate 622. The cleaning blade substrate 622 includes an edge layer 622a and a base layer 622b that have elasticity, and a contact part 62c on the edge layer 622a.

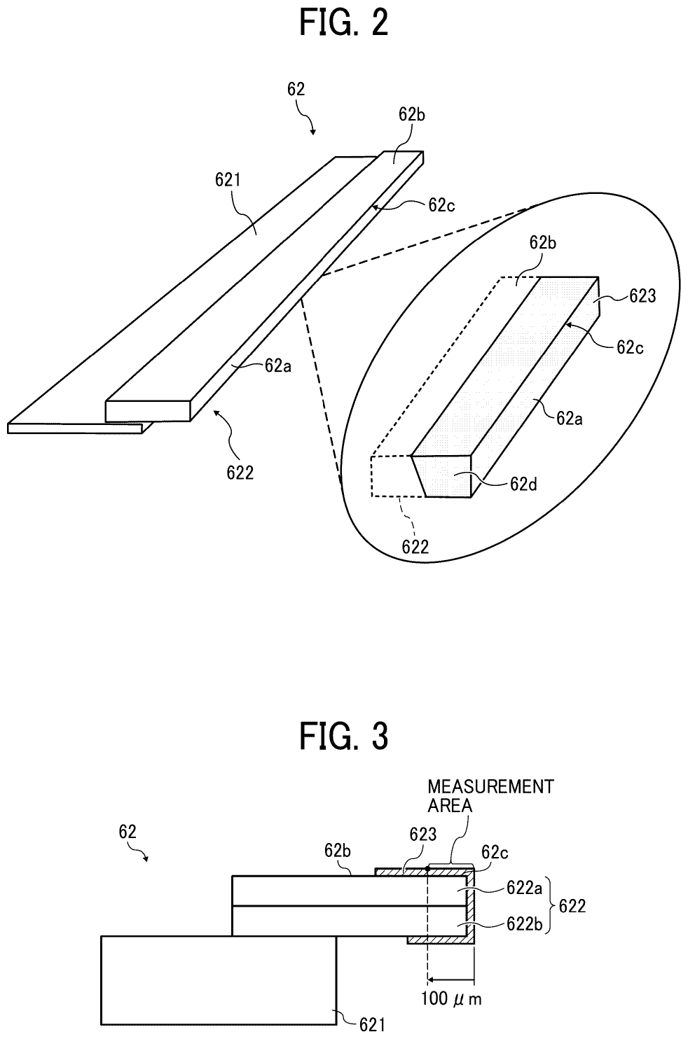

FIG. 2 is a schematic perspective view of the cleaning blade 62 and an enlarged view of a part of the cleaning blade 62. As illustrated in FIG. 2, a coating layer 623 is on at least a part of the contact part 62c and a contact side of the contact part 62c.

FIG. 3 is a schematic cross-sectional view of the cleaning blade 62. The cleaning blade 62 includes the cleaning blade support 621 having a flat shape and the cleaning blade substrate 622 having a flat shape. The cleaning blade support 621 is made of a rigid material such as metal or hard plastic. The cleaning blade substrate 622 has one end coupled to the cleaning blade support 621 and the other end being a free end having a specific length. The cleaning blade substrate 622 is fixed to one end portion of the cleaning blade support 621 with an adhesive. The other end portion of the cleaning blade support 621 is supported by a casing of a cleaner in a cantilever manner. The cleaning blade substrate 622 has a cleaning blade tip face 62a, a cleaning blade cleaning face 62b, the cleaning blade contact part 62c on one end of the cleaning blade substrate 622 that is the free end, and a cleaning blade side face 62d. The coating layer 623 is on the contact side of the cleaning blade contact part 62c and at least a part of the cleaning blade contact part 62c. The cleaning blade 62 is disposed such that the cleaning blade contact part 62c extends in a longitudinal direction of a photoconductor 3 that is a rotational axis direction of the photoconductor 3 and is in contact with the surface of the photoconductor 3.

As illustrated in FIGS. 1 to 3, the cleaning blade substrate 622 has a face disposed on the cleaning blade support 621 and the cleaning blade cleaning face 62b that is not disposed on the cleaning blade support 621.

The following describes an example in which the cleaning blade cleans an image bearer as the cleaning target (in other words, the object). In addition, the cleaning blade substrate may be referred to simply as a blade substrate in the following description.

### Cleaning Blade

The cleaning blade according to the present disclosure is in contact with the surface of the cleaning target (in other words, the object) to remove a residue on the surface of the cleaning target. The cleaning blade includes the cleaning blade substrate including an elastic body and the cleaning blade support supporting the cleaning blade substrate. The cleaning blade includes the coating layer on a tip portion of the elastic body. The tip portion contacts the cleaning target. The coating layer has a developed interfacial area ratio Sdr of 1.2% or more and 1.8% or less in a 100 μm square region inward from a tip ridge of the coating layer on the cleaning face of the cleaning blade substrate. The cleaning blade further includes other members as necessary. The cleaning blade comes into contact with the surface of the image bearer to remove the residue adhering to the image bearer.

The residue is not limited to certain matters as long as the residue adheres to the surface of the image bearer and is to be removed by the cleaning blade. Examples of the residue include, but are not limited to, toner, lubricant, inorganic particles, organic particles, paper dust, other dust, and mixtures thereof.

A conventional cleaning blade has a drawback that, as the cleaning blade comes into contact with the image bearer, the torque that is a force required for rotating the image bearer increases due to friction generated between the cleaning blade and the image bearer, and the image bearer thereby stops rotating. The friction causes abrasion of the contact part of the cleaning blade contacting the image bearer, turning up the cleaning blade, and toner to slip through the cleaning blade, resulting in defective cleaning.

In attempting to enhance the slidability of the cleaning blade and preventing the cleaning blade from turning up or increasing the torque, a process called “touch-up” is widely employed for applying a lubricant, such as a metal soap (e.g., zinc stearate) and PMMA (i.e., polymethacrylic acid) particles, to the tip portion of the cleaning blade. Typically, with the operation of an image forming apparatus, toner gradually remains between the cleaning blade and the image bearer, and the toner functions as a lubricant. Therefore, the lubricant just needs to exhibit lubrication characteristics in a short period from the start of operation of the image forming apparatus until the stabilization of the behavior of the cleaning blade. However, fine particles contained in the conventional lubricant have a weak adhesive force to the substrate and undesirably detach from the cleaning blade before the behavior of the cleaning blade gets stabilized.

In order to reduce particles detaching from the cleaning blade, a technique of applying lubricant including particles and a binder resin fixing the particles to the contact part of the cleaning blade contacting the image bearer may be considered. Since the binder resin prevents the particles from detaching from the cleaning blade, this technique has an effect to prevent the increase of the torque. However, this technique promotes the lubricant to remain on the cleaning blade. This causes the tip portion of the cleaning blade to be less likely to be exposed, which reduces the pressure applied to the contact part with the image bearer. As a result, the cleaning property deteriorates. The deterioration in the cleaning property is apparent when the amount of the toner entering the nip between the cleaning blade and the image bearer is large, for example, when solid images on entire sheets are continuously printed.

As a result of intensive studies, the present inventor found the following. Specifically, the present inventor focused on the surface area of the coating layer made of lubricant. Increasing the surface area of the coating layer (for example, increasing the denseness of the film on the surface of the coating layer) increases a real contact surface area with the image bearer. The increase in the real contact surface area increases the frictional force, which causes the coating layer to be easily abraded. As a result, increasing the surface area of the coating layer prevents the torque from increasing, additionally promotes the coating layer at the tip portion of the cleaning blade to be easily abraded, early exposes the tip portion of the cleaning blade, and early increases the pressure applied to the contact part with the image bearer. Accordingly, increasing the surface area of the coating layer enables the cleaning property to satisfactorily maintain even when the amount of the toner entering the nip between the cleaning blade and the image bearer is large, for example, even when solid images on entire sheets are continuously printed. As a result, the present inventor found that increasing the surface area of the coating layer can achieve both preventing the torque from increasing and satisfactorily maintaining the cleaning property.

The present inventor found that the above-described surface area of the coating layer is preferably expressed by the developed interfacial area ratio Sdr representing the ratio of increase in the surface area in a certain observed image area. The larger the developed interfacial area ratio Sdr, the denser the surface shape and the more the surface is uneven.

As a result, the present inventor found that configuring the cleaning blade that contacts the surface of the cleaning target to remove the residue on the surface of the cleaning target as follows can reduce the increase in the torque immediately after the start of using the image forming apparatus and achieve a good cleaning performance. The cleaning blade includes the cleaning blade substrate including the elastic body and the cleaning blade support supporting the cleaning blade substrate. The cleaning blade includes the coating layer on the tip portion of the elastic body, and the tip portion contacts the cleaning target. The coating layer has the developed interfacial area ratio Sdr of 1.2% or more and 1.8% or less in a 100 μm square region inward from the tip ridge of the coating layer on the cleaning face of the cleaning blade substrate. The increase in torque immediately after the start of use of the image forming apparatus in the cleaning blade configured as described above is smaller than that of a cleaning blade not configured as described above. In addition, the cleaning blade configured as described above has good cleaning performance even when the amount of the toner entering the nip between the cleaning blade and the image bearer is large, for example, even when solid images on entire sheets are continuously printed.

### Coating Layer

The coating layer contains particles and a binder resin as a binding component immiscible with the particles, and further contains other components as necessary. The coating layer is disposed on peripheral side surfaces of one end of the blade substrate, which is used as a tip of the cleaning blade. The blade substrate is described below. The coating layer may be formed on at least a part of the blade substrate, including the contact side on which the cleaning blade comes into contact with the image bearer. The coating layer may be formed on the entire contact side or on the entire surface of the blade substrate. Among these, it is preferable that the coating layer be formed on the entire contact side. The coating layer coats at least the tip portion of the elastic body of the blade substrate. The coating layer has a tip ridge in contact with the surface of the image bearer as the cleaning target. The coating layer prevents the torque from increasing immediately after the start of use of the image forming apparatus. The coating layer is shaved, and the tip of the elastic body of the blade substrate comes into contact with the image bearer, which enables the cleaning blade to maintain good cleaning performance. In the present disclosure, a surface region of the blade substrate where the coating layer is not provided may be referred to as a non-coating region.

The average thickness of the coating layer is not limited and may be appropriately selected according to the purpose but is preferably 0.5 μm or more and 12 μm or less. The coating layer having an average thickness of 0.5 μm or more has a sufficient sliding effect. The coating layer having an average thickness of 12 μm or less is easily shaved, which gives the effect of maintaining the cleaning property.

At a position 100 μm inward from the tip ridge of the cleaning blade, the thickness of the coating layer on the cleaning face of the cleaning blade substrate is preferably 0.5 μm or more and 12 μm or less, more preferably 3.5 μm or more and 12 μm or less, and still more preferably 3.5 μm or more and 4.5 μm or less.

The average thickness of the coating layer may be an average value of thicknesses (μm) measured at three or more positions of the coating layer. The positions at which the thickness of the coating layer is measured are not limited and may include the position separated inward from the end of the cleaning blade by a distance of 100 μm or the center of the coating layer.

The average thickness of the coating layer can be measured by scraping off a part of the coating layer with a spatula or a cotton swab and measuring the shape thereof using a three-dimensional measuring instrument such as a contact surface roughness meter (SURFTEST SJ-500, product of Mitutoyo Corporation) or a laser microscope (LEXT OLS4100, product of Olympus Corporation).

The coating layer includes particles and a resin serving as a binding component, which is referred to as the binder resin. Preferably, the coating layer has a sea-island structure including the particles as domains (islands) and the binder resin as a matrix (sea). It is preferable to select the type and amount of particles corresponding to the type of binder resin so that the particles become domains.

The shapes of the particles are not limited and may be suitably selected to suit a particular application. The shapes of the particles may be either regular or irregular. Preferably, the shapes of the particles are irregular because the irregular shapes can easily increase the surface area of the coating layer. On the other hand, when the shapes of the particles are regular, the shapes of the particles are preferably spherical. Such a shape is preferable because it is possible to prevent a failure in which particles detached from the coating layer damage the image bearer or the blade substrate of the cleaning blade.

The volume average particle diameter (e.g., 50% volume diameter, median diameter) of the particles is not limited and can be suitably selected to suit a particular application, but is preferably from 0.1 to 1 μm, more preferably from 0.1 to 0.5 μm, and still more preferably from 0.1 to 0.3 μm. When the volume average particle diameter of the particles is 1 μm or less, the particles easily settle in a solvent, and disadvantage that stably dispersing the particles in the solvent is difficult can be prevented. When the volume average particle diameter of the particles is 0.5 μm or less, the particles can be more stably dispersed in a non-aqueous solvent.

The coating layer may contain multiple particles having different particle diameters.

A method for measuring the volume average particle diameter (e.g., 50% volume diameter, median diameter) is not limited and may be suitably selected to suit a particular application, and may be laser diffraction/scattering, dynamic light scattering, or imaging. The volume average particle diameter may be measured, for example, by collecting the particles from the coating layer of the cleaning blade and subjecting the particles to a laser diffraction/scattering measurement using an instrument MICROTRAC (product of Nikkiso Co., Ltd.), or by directly observing and measuring the particles on the cleaning blade using a scanning electron microscope (SEM). The volume average particle diameter of the particles present in the coating layer is almost the same as that of the particles before being added to the dispersion liquid to be applied to the cleaning blade.

The amount of particles contained in the coating layer is not limited and may be selected according to the purpose. However, the coating layer including a relatively larger amount of particles than that of binder resin is brittle and easily detaches the particles. In addition to this point, to obtain the sliding effect, the amount of particles contained in the coating layer is preferably from 80% to 99% by mass, and more preferably from 90% to 98% by mass with respect to the total mass of the coating layer.

The material of the particles is not limited and may be selected according to the purpose. Examples of the material of the particles include polytetrafluoroethylene (PTFE), fluorinated ethylene-propylene copolymer (FEP), perfluoroalkoxy polymer (PFA), chlorotrifluoroethylene copolymer (CTFE), tetrafluoroethylene-chlorotrifluoroethylene copolymer (TFE/CTFE), ethylene-chlorotrifluoroethylene copolymer (ECTFE), and polychlorotrifluoroethylene (PCTFE). Among these options, polytetrafluoroethylene (PTFE) is preferable from the viewpoint of further enhancing the slidability of the cleaning blade.

Appropriately synthesized polytetrafluoroethylene (PTFE) may be used. Alternatively, a commercially available product of polytetrafluoroethylene (PTFE) may be used. Examples of the commercially available product of polytetrafluoroethylene (PTFE) include Dyneon TF Micro Powder TF-9201Z and Dyneon TF Micro Powder TF-9207Z (both manufactured by 3M Company), Nano FLON119N and FLUORO E (both manufactured by Shamrock Co., Ltd.), TLP10F-1 (manufactured by Du Pont-Mitsui Fluorochemicals Co., Ltd., KTL-500F (manufactured by Kitamura Limited), and Algoflon L203F (manufactured by SOLVAY).

The resin as the binding component (the binder resin) functions as a binding component between the coating layer and the elastic body. Adding the binder resin to the coating layer increases the adhesive force of the particles to the cleaning blade substrate and prevents the detachment of the coating layer. Thus, the cleaning blade is prevented from turning up, and an increase in torque is prevented. The binder resin is preferably the matrix (the sea) in the sea-island structure of the coating layer. It is preferable to select the type and amount of binder resin in association with the particles so that the binder resin forms a matrix.

As long as the particles are uniformly and stably dispersed, the binder resin is not limited and may be appropriately selected according to the purpose. Examples of the binder resin include vinylidene fluoride (VdF), hexafluoropropylene (HFP), tetrafluoroethylene (TFE), polyvinyl alcohol resin, and polyvinyl acetal resin. Among these, for enhancing lubricity and adhesion to the blade substrate, a copolymer of these materials is preferred, and a VdF-HFP-TFE terpolymer is more preferred.

Preferably, the proportions of VdF, HFP, and TFE in the VdF-HFP-TFE terpolymer are 30% to 80% by mol, 10% to 35% by mol, and 5% to 35% by mol, respectively, for imparting flexibility to the blade and solubility in solvents.

The combination of the particles and the binder resin is not limited to any one of the examples described above and may be appropriately selected according to the purpose. Examples of the particles include inorganic compound particles, fluorine-based resin particles, and acrylic resin particles. Examples of the binder resin include acrylic resin, styrene resin, and vinyl resin. Examples of the inorganic compounds include silica, alumina, and zirconia. Each of these materials may be used alone or in combination with others. When the particles are made of polytetrafluoroethylene, the preferred binder resin is a fluorine-based resin. When the particles are made of acrylic resin, the preferred binder resin is a polyvinyl alcohol resin or a polyvinyl acetal resin.

As non-fluorine-based resin particles, acrylic resin particles are preferable because the acrylic resin particles have a certain degree of hardness. The certain degree of hardness gives an effect of slidability. The shape of the particle is not limited and may be suitably selected according to the purpose but is preferably spherical. Such a shape is preferable because it is possible to prevent a failure in which the non-fluorine-based resin particles are detached from the coating layer and damage the image bearer or the blade substrate of the cleaning blade.

The volume average particle diameter (e.g., 50% volume diameter, median diameter) of the non-fluorine-based resin particles is not limited and may be suitably selected according to the purpose but is preferably from 0.1 to 1 μm, more preferably 0.5 μm or less, and still more preferably 0.3 μm or less. When the volume average particle diameter of the particles is 1 μm or less, the particles easily settle in a solvent, and disadvantage that stably dispersing the particles in the solvent is difficult can be prevented. When the volume average particle diameter of the particles is 0.5 μm or less, the particles can be more stably dispersed in a non-aqueous solvent.

The method for producing the coating layer is not limited and may be appropriately selected according to the purpose. For example, the coating layer can be obtained by adding particles to a mixture of a solvent and the binder resin and applying a particle dispersion obtained from the mixture to the blade substrate in the cleaning blade.

The solvent is not limited and may be appropriately selected according to the purpose. For example, when fluorine-based particles and the binder resin are used, a fluorine-containing organic solvent may be used as the solvent. Examples of the fluorine-containing organic solvent include hydrofluoroether (HFE), perfluorocarbon (PFC), and perfluoroether (PFE). One of these options may be used alone, or two or more of these options may be used in combination.

An average particle diameter of the particles in the binder resin is measured by a dynamic light scattering method (e.g., an average particle diameter is measured by a cumulant analysis method in scattering intensity distribution) and is preferably 1 μm or less, more preferably 0.5 μm or less, and even more preferably 0.3 μm or less. Typically, fine particles having a volume average particle diameter of 1 μm or less agglomerate into secondary particles having a particle diameter of 1 μm or more.

Dispersing the secondary particles formed by agglomeration to have a particle diameter of 1 μm or less can give fluorine-based resin dispersion that is maintained stable even when stored at a low viscosity for a long period of time. The dispersing method is not limited and may be suitably selected according to the purpose. Examples of the dispersing method include, but are not limited to, methods using a disperser such as ultrasonic disperser, three roll mill, ball mill, bead mill, and jet mill.

A method for forming the coating layer is not limited and may be suitably selected according to the purpose. Examples of the method for forming the coating layer include, but are not limited to, dipping in which the entire or a part of the blade substrate of the cleaning blade is dipped in a particle dispersion. In addition to dipping, spray coating or dispenser coating may also be employed.

### Blade Substrate

In the present disclosure, the blade substrate of the cleaning blade may also be referred to simply as a substrate. The shape of the blade substrate may be suitably selected according to the purpose as long as the blade substrate has a structure capable of removing a residue on the image bearer. Preferably, the contact side of the contact part of the blade substrate that comes into contact with the image bearer is linear. The blade substrate may have, for example, a plate shape.

As illustrated in FIG. 2, the blade substrate includes the tip face 62a, the cleaning face 62b, the contact part 62c, the side face 62d, and the coating layer 623 on at least a part of the contact part 62c including the contact side of the contact part 62c.

### Developed Interfacial Area Ratio (Sdr)

The cleaning blade according to the present embodiment has the developed interfacial area ratio Sdr in a 100 μm square region inward from the tip ridge of the coating layer 623 on the cleaning face 62b of the cleaning blade substrate that is 1.2% or more and 1.8% or less, and preferably 1.4% or more and 1.7% or less. Setting the developed interfacial area ratio Sdr to 1.2% or more gives an effect that the coating layer is sufficiently and easily shaved. Due to the easily shaved film of the coating layer and the sliding effect, both preventing the torque from increasing and satisfactorily maintaining the cleaning property can be achieved. Setting the developed interfacial area ratio Sdr to 1.8% or less prevents the coating layer from being excessively shaved and enables the sliding effect to be sufficient. Since the dense and rough surface of the coating layer containing the particles and the binder resin has a large real contact area with the image bearer and increases a frictional force, the coating layer is liable to be shaved.

### Measurement of Developed Interfacial Area Ratio (Sdr)

The developed interfacial area ratio Sdr can be acquired from an observation image obtained by a confocal laser microscope. In the present disclosure, the measurement of the developed interfacial area ratio is performed on the cleaning blade having been processed. Specifically, a luminance image of the surface of the coating layer is acquired using a confocal laser microscope (OLS-4100, manufactured by Olympus Corporation) and a 100-fold magnification objective lens. The developed interfacial area ratio Sdr in a 100 μm square from the tip ridge is acquired by an attached analysis application.

### Martens Hardness

The Martens hardness of the blade substrate in the cleaning blade of the present embodiment is not limited and may be suitably selected according to the purpose, but is preferably from 0.5 to 2 N/mm². When the Martens hardness of the blade substrate in the cleaning blade is within the above desired range, undesirable phenomena such as defective cleaning and chipping can be prevented. The defective cleaning is caused when the linear pressure of the blade hardly achieves a desired level and the area of the contact part with an image bearer increases, and the chipping is caused when the blade substrate is excessively hard.

### Measurement of Martens Hardness

The Martens hardness may be measured at any position. For ease of measurement, the present inventor measured the Martens hardness at a position separated from the end of the base layer to the inside by a distance of 20 μm. The Martens hardness is the median of the numerical values measured at 4 to 6 positions. The Martens hardness was measured according to ISO 14577 using a nanoindenter (ENT-3100, product of ELIONIX INC.) by continuously pushing a Berkovich indenter into a sample for 10 seconds until a load reaches a maximum load of 1,000 μN, holding for 5 seconds, and pulling the indenter with the same loading rate for 10 seconds. The Martens hardness obtained under the above-described conditions was adopted.

### Rebound Resilience

The rebound resilience of the blade substrate in the cleaning blade of the present embodiment is not limited and may be suitably selected according to the purpose but is preferably from 10% to 80% at 23° C. When the rebound resilience is within the desired range, undesirable phenomena such as defective cleaning and blade squeak can be prevented. The defective cleaning occurs when the entire blade substrate has lost flexibility and becomes unable to follow the runout or roughness of the image bearer, and the blade squeak (i.e., abnormal sound) occurs when the resilience becomes too strong.

### Measurement of Rebound Resilience

The rebound resilience of the blade substrate can be measured according to JIS K6255 standard at 23° C. using, for example, a resilience tester No. 221, product of Toyo Seiki Seisaku-sho, Ltd.

The structure of the blade substrate is not limited and may be suitably selected according to the purpose. Examples of the structure include, but are not limited to, a single-layer structure, a laminated structure, and a laminated structure which combines multiple members. Among these, the single-layer structure and the laminated structure which combines multiple members are preferred in view of easy processing into the cleaning blade. The blade substrate having the laminated structure includes a layer that abuts against the image bearer and is referred to as an edge layer and another layer that is referred to as a base layer. The blade substrate having the monolayer structure includes only the edge layer. In the laminated structure which combines multiple members, it is preferable that the Martens hardness values of the multiple members be different from each other.

The material of the blade substrate is not limited and may be suitably selected according to the purpose. For preventing wear of the blade substrate and sufficiently removing the residue from the image bearer, it is preferable that the material have appropriate elasticity and hardness. The material of the blade substrate may be, for example, an elastic material. As long as the elastic material has high elasticity, the elastic material is not limited and may be suitably selected according to the purpose. Examples of the elastic material include, but are not limited to, polyurethane rubber, silicone rubber, fluororubber, nitrile rubber (NBR), and ethylene propylene diene rubber (EPDM).

Among these, polyurethane rubber is preferred for its durability and non-staining properties.

The size of the blade substrate is not limited and may be suitably selected depending on the size of the image bearer.

A method for producing the blade substrate is not limited and may be suitably selected according to the purpose. For example, the blade substrate can be produced through the processes of: preparing a polyurethane prepolymer from a polyol compound and a polyisocyanate compound; adding a curing agent, optionally along with a curing catalyst, to the polyurethane prepolymer; centrifugal molding the resultant using a mold; leaving the resultant at room temperature for aging; and cutting the resultant into a flat plate having a predetermined size.

The polyol compound is not limited and may be suitably selected according to the purpose. Examples of the polyol compound include, but are not limited to, high-molecular-weight polyols and low-molecular-weight polyols.

Examples of the high-molecular-weight polyols include, but are not limited to, a polyester polyol which is a condensate of an alkylene glycol and an aliphatic diprotic acid; polyester-based polyols, such as polyester polyols of alkylene glycols with adipic acid, such as ethylene adipate ester polyol, butylene adipate ester polyol, hexylene adipate ester polyol, ethylene propylene adipate ester polyol, ethylene butylene adipate ester polyol, and ethylene neopentylene adipate ester polyol; polycaprolactone-based polyols such as polycaprolactone ester polyols obtained by ring-opening polymerization of caprolactone; and polyether-based polyols such as poly(oxytetramethylene) glycol and poly(oxypropylene) glycol. Each of these can be used alone or in combination.

Examples of the low-molecular-weight polyols include, but are not limited to, divalent alcohols such as 1,4-butanediol, ethylene glycol, neopentyl glycol, hydroquinone-bis(2-hydroxyethyl) ether, 3,3′-dichloro-4,4′-diaminodiphenylmethane, and 4,4′-diaminodiphenylmethane; and trivalent or higher polyols such as 1,1,1-trimethylolpropane, glycerin, 1,2,6-hexanetriol, 1,2,4-butanetriol, trimethylolethane, 1,1,1-tris(hydroxyethoxymethyl)propane, diglycerin, and pentaerythritol. Each of these can be used alone or in combination.

The polyisocyanate compound is not limited and may be suitably selected according to the purpose. Examples of the polyisocyanate include, but are not limited to, methylene diphenyl diisocyanate (MDI), tolylene diisocyanate (TDI), xylylene diisocyanate (XDI), naphthylene 1,5-diisocyanate (NDI), tetramethylxylene diisocyanate (TMXDI), isophorone diisocyanate (IPDI), hydrogenated xylylene diisocyanate (H6XDI), dicyclohexylmethane diisocyanate (H12MDI), hexamethylene diisocyanate (HDI), dimer acid diisocyanate (DDI), norbornene diisocyanate (NBDI), and trimethylhexamethylene diisocyanate (TMDI). Each of these can be used alone or in combination.

The curing agent is not limited and may be suitably selected according to the purpose. Examples of curing agent include, but are not limited to, amines and alcohols. Each of these can be used alone or in combination. The curing agent can be used to adjust the hardness of the blade substrate.

The curing catalyst is not limited and may be suitably selected according to the purpose. Examples of the curing catalyst include, but are not limited to, 2-methylimidazole and 1,2-dimethylimidazole. The proportion of the curing catalyst to the total mass of the prepolymer and the curing agent is not limited and may be suitably selected according to the purpose, but is preferably from 0.01% to 0.5% by mass, more preferably from 0.05% to 0.3% by mass.

### Image Forming Apparatus and Image Forming Method

An image forming apparatus of the present embodiment includes: an image bearer; a charger to charge a surface of the image bearer; an irradiator to irradiate the charged surface of the image bearer with light to form an electrostatic latent image; a developing device to develop the electrostatic latent image into a visible image; a transfer device to transfer the visible image onto a recording medium via an intermediate transferor; a fixing device to fix the transferred visible image on the recording medium; and a cleaner to remove a residue (e.g., toner) on the intermediate transferor. The image forming apparatus may further include other devices as necessary. The charger and the irradiator may be collectively referred to as an “electrostatic latent image forming device”. The cleaner includes the cleaning blade.

An image forming method of the present disclosure includes a charging process, an irradiation process, a developing process, a transfer process, a fixing process, and a cleaning process, and further includes other processes as necessary. The charging and irradiation processes may be collectively referred to as an “electrostatic latent image forming process.”

The image forming method is suitably performed by the image forming apparatus. The charging process can be performed by the charger. The irradiation process can be performed by the irradiator. The developing process can be performed by the developing device. The transfer process can be performed by the transfer device. The fixing process can be performed by the fixing device. The cleaning process can be performed by the cleaner. The cleaner contains the cleaning blade of the present embodiment. The other processes can be performed by the other corresponding devices.

### Image Bearer

The structure and size of the image bearer are not limited and may be suitably selected from known ones. The shape of the image bearer is not limited and may be suitably selected according to the purpose. Examples of the shape of the image bearer include, but are not limited to, a drum shape and a belt shape. The material of the image bearer is not limited and may be suitably selected according to the purpose. Examples of the material of the image bearer include, but are not limited to, inorganic photoconductors such as amorphous silicon and selenium, and organic photoconductors (OPC) such as polysilane and phthalopolymethine.

As the organic photoconductor, there are a laminated type photoconductor and a single-layer type photoconductor. The laminated type photoconductor has a laminated structure containing a layer (a charge generation layer) in which charge-generating materials such as non-metallic phthalocyanine or titanyl phthalocyanine are dispersed in a binder resin and a layer (a charge transport layer) in which charge transport materials are dispersed in a binder resin. These layers are stacked on a support such as an aluminum drum. The single-layer type photoconductor has a single-layer structure with a photosensitive layer containing both charge-generating materials and charge transport materials dispersed in a binder resin on a support.

In the single-layer type photoconductor, hole transport agents and electron transport agents as charge transport materials are added to the photosensitive layer.

Additionally, the option exists to include an undercoat layer between the support and either the charge-generation layer in the laminated type photoconductor or the photosensitive layer in the single-layer type photoconductor.

### Charger and Charging Process

In the charging process, the charger charges the surface of the image bearer. As long as the charger can charge the surface of the image bearer, the charger is not limited and may be suitably selected according to the purpose. Examples of the charger include, but are not limited to, contact chargers equipped with a conductive or semiconductive roller, brush, film, or rubber blade, and non-contact chargers employing corona discharge such as a corotron and a scorotron.

The shape of the charger is determined in accordance with the specification or configuration of the electrophotographic image forming apparatus, and may be in the form of a roller, a magnetic brush, or a fur brush. The magnetic brush may include various ferrite particles (e.g., Zn—Cu ferrite) serving as the charger, a non-magnetic conductive sleeve for supporting the ferrite particles, and a magnet roll contained inside the conductive sleeve.

The fur brush may be made of fur having been subjected to a conductive treatment with carbon, copper sulfide, a metal, or a metal oxide. Such fur is wound around or attached to a metal cored bar or a cored bar having been subjected to a conductive treatment to be formed into the charger.

The charger is not limited to the contact charger. However, the contact charger is preferred because the amount of ozone generated by the contact charger is small. Preferably, the charger is disposed to be in or out of contact with the image bearer and charges the surface of the image bearer by applying a direct-current voltage and an alternating-current voltage superimposed on one another. A charging roller disposed close to but out of contact with the image bearer via a gap tape is also preferable as the charger, and applying the direct-current voltage and the alternating-current voltage superimposed on one another to the charging roller charges the surface of the image bearer.

### Irradiator and Irradiation Process

The irradiation process is a process of irradiating the charged surface of the image bearer with light and is performed by the irradiator. The irradiator irradiates the surface of the image bearer with light to form the electrostatic latent image. An optical system in the irradiator is roughly divided into an analog optical system and a digital optical system. The analog optical system directly projects an original document onto the surface of the image bearer. The digital optical system receives image data as electrical signals, converts the electrical signals into optical signals, and irradiates the image bearer with the optical signals to form the image.

The irradiator is not limited and may be suitably selected according to the purpose as long as it is capable of irradiating the charged image bearer with light to form the electrostatic latent image. Examples of the irradiator include, but are not limited to, various irradiators such as a copying optical system, a rod lens array system, a laser optical system, a liquid crystal shutter optical system, and LED optical system. The irradiation can also be conducted by irradiating the back surface of the image bearer with light to form the image.

### Developing Device and Developing Process

In the developing process, the developing device develops the electrostatic latent image into a toner image. The developing device is not limited and may be suitably selected according to the purpose as long as the developing device can develop the electrostatic latent image with the toner. Examples of the developing device include developing devices that store the toner and develop the electrostatic latent image by a contact developing method or a non-contact developing method. The developing device may be either a dry developing type or a wet developing type. The developing device may be either a monochrome developing device or a multicolor developing device. For example, the developing device includes a stirrer that stirs developer to triboelectrically charge the toner and a rotatable magnet roller. In the developing device, toner particles and carrier particles are mixed and stirred. The toner particles are charged by friction and retained on the surface of the rotating magnet roller, thus forming a magnetic brush. The magnet roller is disposed proximity to the image bearer, so that a part of the toner particles composing the magnetic brush formed on the surface of the magnet roller are moved to the surface of the image bearer by an electric attractive force of the electrostatic latent image. As a result, the electrostatic latent image is developed with the toner to form the toner image on the surface of the image bearer. The toner contained in the developing device may be a developer containing the toner, and the developer may be either a one-component developer or a two-component developer. The toner may be either a magnetic toner used as a one-component developer without using a carrier, or a non-magnetic toner.

A premix developer system may be adopted as the developing system. In the premix developer system, a premix developer in which the toner and the carrier are mixed in advance is supplied to the developing device. The amount of carrier in the developing device increases, but the increased amount of the carrier is discharged as an excess developer in the premix developer system. As a result, the developer in the developing device is gradually refreshed. The premix developer system can extend the replacement cycle due to the deterioration of the developer and save the work of replacing the developer.

### Transfer Process and Transferor

In the transfer process, the transferor transfers the toner image onto the recording medium. The transfer process preferably includes: a primary transfer process of transferring the toner image onto the surface of the intermediate transferor to form a composite transfer image; and a secondary transfer process of transferring the composite transfer image onto the recording medium. The transfer device is not limited and may be suitably selected according to the purpose as long as the transfer device can transfer the toner image onto the recording medium. Preferably, the transfer device includes: a primary transfer device that transfers the toner image onto the surface of the intermediate transferor to form the composite transfer image; and a secondary transfer device that transfers the composite transfer image onto the recording medium. The primary transfer device forms a primary transfer electric field moving the toner from the image bearer to the intermediate transferor, and the secondary transfer device forms a secondary transfer electric field moving the toner from the intermediate transferor to the recording medium. The transferor is not limited and may be suitably selected according to the purpose. Examples of the transferor include, but are not limited to, a corona transferor utilizing corona discharge, a transfer belt, a transfer roller, a pressure transfer roller, and an adhesive transferor. The number of the transferors is at least one and may be two or more.

The recording medium is not limited and may be suitably selected according to the purpose as long as the developed and unfixed toner image can be transferred thereon. Examples of the recording medium include, but are not limited to, plain paper and polyethylene terephthalate (PET) sheets for overhead projectors (OHP).

### Fixing Process and Fixing Device

In the fixing process, the fixing device fixes the toner transferred to the recording medium onto the recording medium. For example, the fixing device includes a heater, a fixing belt, and a pressure roller. The heater heats the fixing belt to a fixing target temperature in a range from 80° C. to 200° C. The pressure roller is pressed against the fixing belt to form a fixing nip. The recording medium passes through the fixing nip, and heat and pressure are applied to the toner on the recording medium to fix the toner onto the recording medium. Various types of fixing devices exist and are used.

### Cleaning Process and Cleaner

The cleaning process is a process of removing the toner remaining on the surface of the image bearer and is performed by the cleaner. The cleaner includes the cleaning blade fixed on a support.

The linear pressure applied to the surface of the image bearer by the blade substrate of the cleaning blade is not limited and may be suitably selected according to the purpose but is preferably from 10 to 100 N/m, and more preferably from 10 to 50 N/m. When the linear pressure is from 10 to 100 N/m, defective cleaning in which the toner slips through between the contact part and the image bearer is less likely to occur, and the elastic body is prevented from being turned up. The linear pressure can be measured using, for example, a measuring apparatus incorporating a small compression load cell available from KYOWA ELECTRONIC INSTRUMENTS CO., LTD.

The cleaning blade forms an angle, which is referred to as a cleaning angle below. The cleaning angle is formed between a tangent line of the image bearer at a position at which the contact part of the cleaning substrate of the cleaning blade comes into contact with the image bearer and the tip surface of the free end of the blade substrate. In the present disclosure, the cleaning angle is not limited and may be suitably selected according to the purpose but is preferably from 65° to 85°. Setting the cleaning angle to be from 65° to 85° can prevent the blade substrate from being turned up and reduce the occurrence of defective cleaning.

### Other Processes and Other Devices

The other processes may include, for example, a neutralization process, a recycle process, and a control process. The other devices may include, for example, a neutralizer, a recycler, and a controller.

### Neutralization Process and Neutralizer

In the neutralization process, the neutralizer such as a neutralization lamp uniformly reduces the electric potential of the image bearer. The neutralizer is not limited to the neutralization lamp and may be a corona discharger.

### Recycle Process and Recycler

In the recycling process, the recycler recycles the toner removed by the cleaning process to the developing device. The recycler is not limited and may be suitably selected according to the purpose. Examples of the recycler include, but are not limited to, a conveyor.

### Control Process and Controller

In the control process, the controller controls the above-described processes. The controller is not limited to a certain device and may be suitably selected according to the purpose as long as the controller can control the above-described processes. Examples of the controller include, but are not limited to, a sequencer and a computer.

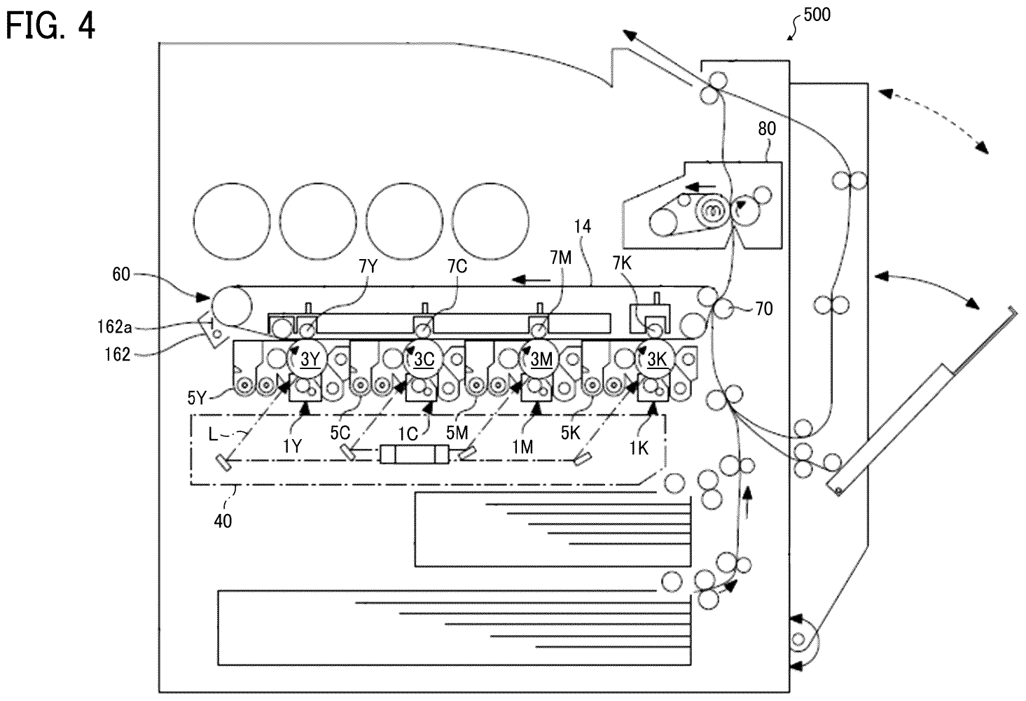

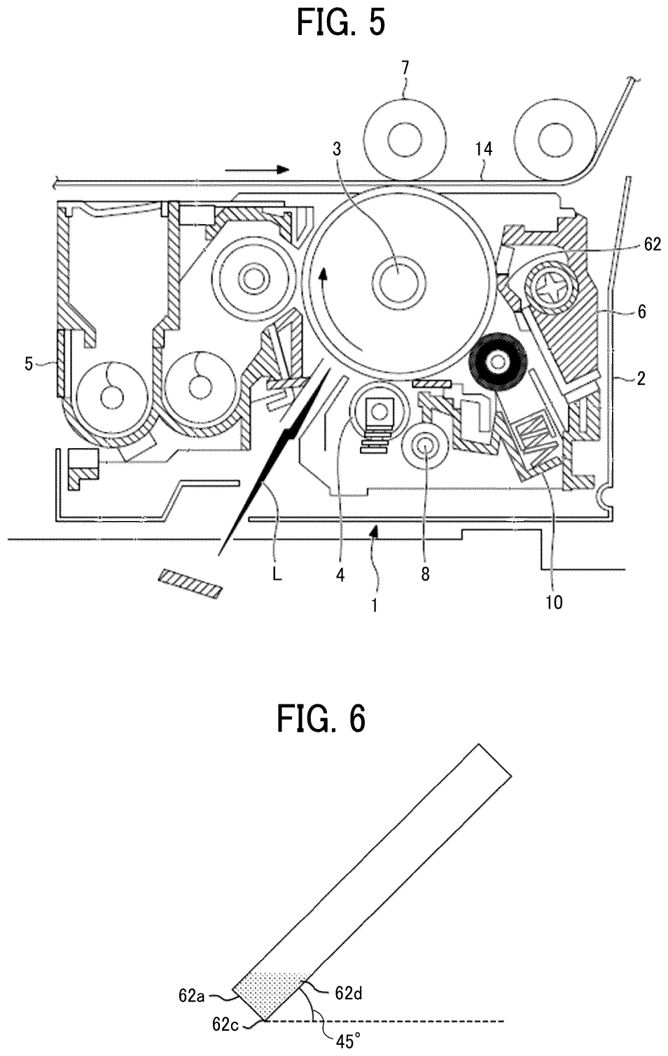

An image forming apparatus 500 is described below with reference to FIGS. 4 and 5. The applications of the cleaning blade are provided herein for the purpose of illustration only and are not intended to be limiting. Identical or similar reference signs are given to elements similar to those illustrated in each drawing, and redundant explanation may be omitted. The number, position, and shape of the members described below are not limited to those in the embodiments described below and can be suitably set to suit a particular application.

### Process Cartridge

A process cartridge includes: an image bearer; at least one of the charger to charge the surface of the image bearer, the irradiator to irradiate the charged surface of the image bearer with light to form the electrostatic latent image, the developing device to develop the electrostatic latent image to the toner image, or the transferor to transfer the toner image onto the recording medium; and the cleaner including the cleaning blade to remove the residue remaining on the surface of the image bearer. The process cartridge is detachably attachable to a body of an image forming apparatus. The process cartridge may further include other members, if necessary.

As illustrated in FIG. 5, each of the process cartridges 1 in the image forming apparatus 500 has a frame body 2 accommodating an image bearer 3 and processing devices including a charging roller 4, a developing device 5, a cleaner 6, and a lubrication device 10. The process cartridge 1 is integrally attachable to and detachable from the body of the image forming apparatus 500. In the image forming apparatus 500, the image bearer 3 and the processing devices are replaceable at the same time by replacing each of the process cartridges. Alternatively, each of the image bearer 3, the charging roller 4 as a charger, a charging roller cleaner 8, the developing device 5, the cleaner 6, and the lubrication device 10 may be independently replaceable.

Specifically, as illustrated in FIG. 4, the image forming apparatus 500 includes process cartridges 1Y, 1C, 1M, and 1K. The process cartridges 1Y, 1C, 1M, and 1K include a photoconductor drum 3Y for yellow, a photoconductor drum 3C for cyan, a photoconductor drum 3M for magenta, and a photoconductor drum 3K for black, respectively. Each of photoconductor drums serves as the image bearer. Additionally, the process cartridges 1Y, 1C, 1M, and 1K include the charging rollers 4, respectively to uniformly charge the photoconductor drums. The image forming apparatus 500 includes an irradiator 40 to irradiate the charged surface of the photoconductor drums 3Y, 3C, 3M, and 3K with light to form the electrostatic latent images for yellow, cyan, magenta, and black on the photoconductor drums 3Y, 3C, 3M, and 3K based on image data for yellow, cyan, magenta, and black. To develop the latent images to form toner images, the process cartridges 1Y, 1C, 1M, and 1K include a yellow developing device 5Y, a cyan developing device 5C, a magenta developing device 5M, and a black developing device 5K, respectively. The image forming apparatus 500 includes a transferor 60 including an intermediate transfer belt 14, primary transferors 7Y, 7C, 7M, and 7K to transfer toner images to an intermediate transfer belt 14, and a secondary transfer roller 70 to transfer toner images superimposed on the intermediate transfer belt 14 to the recording medium. Each of the process cartridges includes the cleaner 6 including the cleaning blade 62 to clean toner remaining on each of the photoconductor drums. In addition, the image forming apparatus 500 includes a belt cleaner 162 including a blade 162a to clean toner remaining on the intermediate transfer belt. The structure of the blade 162a may be the same as the structure of the cleaning blade 62. The toner image transferred onto the recording medium is fixed onto the recording medium by a fixing device 80 in the image forming apparatus 500.

### EXAMPLES

Examples regarding the present disclosure and comparative examples are described below, but the present disclosure is not limited to the following examples. In the following descriptions, “parts” represents “parts by mass” unless otherwise specified.

In the following description, the cleaning blade substrate illustrated in FIG. 4 includes the base layer and the edge layer having elasticity.

### Production of Particle Dispersion for Forming Coating Layer

### Preparation of Particle Dispersion A

A particle dispersion A was prepared by putting the following materials in a screw tube and stirring the mixture using a stirrer. The materials were 3.4 parts of a polytetrafluoroethylene (PTFE) micropowder (TF9201Z, product of 3M Company, having a volume average particle diameter of 200 nm) as the particles, 3.4 parts of a polytetrafluoroethylene (PTFE) micropowder (TF9207Z, product of 3M Company, having a volume average particle diameter of 120 nm) as the particles, 0.2 parts of a VdF-HFP-TFE terpolymer composed of vinylidene fluoride (VdF), hexafluoropropylene (HFP), and tetrafluoroethylene (TFE) as the binder resin, and 93 parts of 1,1,2,2-tetrafluoroethyl 2,2,2-trifluoroethyl ether (HFE-347, product of Tokyo Chemical Industry Co., Ltd.) as a fluorine-based dispersion medium.

### Preparation of Particle Dispersion B

A particle dispersion B was prepared by putting the following materials in the screw tube and stirring the mixture using the stirrer. The materials were 3.55 parts of the polytetrafluoroethylene (PTFE) micropowder (TF9201Z, product of 3M Company, having a volume average particle diameter of 200 nm) as the particles, 3.3 parts of the polytetrafluoroethylene (PTFE) micropowder (TF9207Z, product of 3M Company, having a volume average particle diameter of 120 nm) as the particles, 0.15 parts of the VdF-HFP-TFE terpolymer composed as the binder resin, and 93 parts of 1,1,2,2-tetrafluoroethyl 2,2,2-trifluoroethyl ether (HFE-347, product of Tokyo Chemical Industry Co., Ltd.) as the fluorine-based dispersion medium.

### Preparation of Particle Dispersion C

A particle dispersion C was prepared by putting the following materials in the screw tube and stirring the mixture using the stirrer. The materials were 6.8 parts of the polytetrafluoroethylene (PTFE) micropowder (TF9201Z, product of 3M Company, having a volume average particle diameter of 200 nm) as the particles, 0.2 parts of the VdF-HFP-TFE terpolymer composed as the binder resin, and 93 parts of 1,1,2,2-tetrafluoroethyl 2,2,2-trifluoroethyl ether (HFE-347, product of Tokyo Chemical Industry Co., Ltd.) as the fluorine-based dispersion medium.

### Preparation of Particle Dispersion D

A particle dispersion D was prepared by putting the following materials in the screw tube and stirring the mixture using the stirrer. The materials were 97.0 parts of an aqueous dispersion of polymethyl methacrylate (PMMA) (MX100W, product of NIPPON SHOKUBAI CO., LTD., having a volume average particle diameter of 150 nm) as the particles and 3.0 parts of polyvinyl butyral (PVB) (S-LEC KW-10, product of SEKISUI CHEMICAL CO., LTD., having a degree of acetalization of 9±2 mol %) as the binder resin.

### Preparation of Particle Dispersion E

A particle dispersion E was prepared by putting the following materials in the screw tube and stirring the mixture using the stirrer. The materials were 95.0 parts of an aqueous dispersion of polymethyl methacrylate (PMMA) (MX100W, product of NIPPON SHOKUBAI CO., LTD., having a volume average particle diameter of 150 nm) as the particles and 5 parts of polyvinyl alcohol (PVA) resin (POVAL JP-03 manufactured by Japan Vam & Poval Co., Ltd, having a saponification degree of 88±2 mol %) as the binder resin.

### Example 1

### Preparation of Blade Substrate of Cleaning Blade

Polyurethane elastomer sheets obtained through the processes of centrifugal molding, curing, and post-crosslinking were respectively used for the edge layer and the base layer. The average thickness and Martens hardness (HM) of each of the edge layer and the base layer were as follows.
Average thickness: 2.0 [mm]
Martens hardness (HM) of the edge layer: 0.5 [N/mm²]
Martens hardness (HM) of the base layer: 1.1 [N/mm²]The edge layer and the base layer were bonded to each other to prepare the blade substrate. The blade substrate was bonded to a metal plate.

### Formation of Coating Layer: Dipping

One end face of the peripheral side surfaces of the cleaning blade, which is used as the tip of the cleaning blade and may be referred to as a cleaning blade tip surface, was dipped in the particle dispersion A at a right angle to a horizontal plane by a depth of 2 mm from the cleaning blade tip surface, and pulled up at a pulling rate of 1 mm/s. For the purpose of collecting the PTFE particles that impart the cleaning function in a portion including the contact side of the cleaning blade tip surface, the cleaning blade was tilted by about 45°, as illustrated in FIG. 6, and dried at room temperature (25° C.) for 30 minutes. Thus, a cleaning blade of Example 1 was prepared. The average thickness of the coating layer was 0.5 μm.

### Examples 2 to 8 and Comparative Examples 1 to 3

Cleaning blades of Examples 2 to 8 and comparative examples 1 to 3 were prepared in the same manner as in Example 1 except that the type of the particle dispersion, the Martens hardness of the base layer, and the average thickness of the coating layer were changed as presented in Table 1. The thickness of the coating layer was controlled by the pulling rate during dipping. The thickness increases with increasing pulling rate. The cleaning blade of Comparative Example 1 includes a blade substrate provided with no coating layer.

### Assembly of Image Forming Apparatus

Each of the cleaning blades obtained in Examples 1 to 8 and Comparative Examples 1 to 3 was mounted on a process cartridge of a color multifunction peripheral (IMAGIO MP C4500, product of Ricoh Co., Ltd.) including a printer part that has the same configuration as the image forming apparatus 500 illustrated in FIG. 4, to assemble an image forming apparatus. The cleaning blade was mounted on the image forming apparatus so as to exhibit a linear pressure of 20 g/cm and a cleaning angle of 81°.

### Measurement of Developed Interfacial Area Ratio (Sdr)

The developed interfacial area ratio Sdr was measured for the coating layer of the cleaning blade obtained in each of Examples 1 to 8 and Comparative Examples 1 to 3. As a method for measuring the developed interfacial area ratio Sdr, the measurement method described in the section of “Developed Interfacial Area Ratio (Sdr)” described above was adopted. The developed interfacial area ratio Sdr illustrated in Table 1 is a median of values measured at 4 to 6 positions in each measurement area of each blade.

### Measurement of Martens Hardness

The Martens hardness of the base layer of each of the cleaning blades obtained in Examples 1 to 8 and Comparative Examples 1 to 3 were measured. The method for measuring the Martens hardness (HM) is the same as the measurement in the “Measurement of Martens hardness” described above. The results are presented in Table 1. The Martens hardness of the base layer was measured at a position 20 um distant from the end portion of the base layer. The Martens hardness was the median of the values measured at 4 to 6 positions in each measurement area.

### Measurement of Average Thickness of Coating Layer

The average thickness of the coating layer of each of the cleaning blades obtained in Examples 1 to 8 and Comparative Examples 1 to 3 was measured. The results are presented in Table 1. The average thickness was measured by scraping off a part of the coating layer with a spatula or a cotton swab and measuring the shape thereof using a contact surface roughness meter (SURFTEST SJ-500, product of Mitutoyo Corporation).

### Evaluation of Torque Increase Rate

The above-prepared imaging apparatus was made to produce output under the following conditions to measure the rate of change in the driving torque increase of the image bearer. After the output, the tip portion of the cleaning blade was observed with a laser microscope (LEXT OLS4100, product of Olympus Corporation), and the torque increase rate was evaluated based on the following criteria. The evaluation results are presented in Table 1. The “initial value” defined in the evaluation criteria refers to the value obtained in the initial stage in which the 1st to 500th sheets were output.
Environment: 23° C./45% RH
Output condition: White sheet chart
Number of output sheets: 5,000 sheets (A4size horizontal)

### Evaluation Criteria

A: The rate of change in torque increase was within 50% of the initial value, and the image bearer did not stop due to an increase in driving torque. The tip portion of the cleaning blade was observed to have no trace of turning-up even after the output.

B: The rate of change in torque increase was within 50% of the initial value, and the image bearer did not stop due to an increase in driving torque. The tip portion of the cleaning blade was observed to have a trace of turning-up after the output, but it was not at such a level that the cleaning blade allowed the toner to pass through. No problem in practical use.

C: The image bearer stopped due to an increase in torque. The tip portion of the cleaning blade was observed to have a trace of turning-up after the output to such an extent that the toner passed through the cleaning blade. Not suitable for practical use.

### Evaluation of Image Quality (Cleaning Performance)

The above-prepared image forming apparatus was made to produce output under the following conditions. After that, the tip portion of the cleaning blade and the surface of the image bearer were observed with a laser microscope (LEXT OLS4100, product of Olympus

Corporation) and evaluated based on the following criteria. The evaluation results are presented in Table 1.
Environment: 27° C./80% RH
Output condition: Continuously outputting a chart having an image area ratio of 100% (i.e., a solid image printed on the entire sheet)
Number of output sheets: 2000 sheets (A4 size horizontal)

### Evaluation Criteria

A: Toner particles having slipped through due to defective cleaning are not visually confirmed on either the print sheet or the image bearer, and no streak-like toner slippage is confirmed even when the image bearer is observed with a microscope in the longitudinal direction.

B: Toner particles having slipped through due to defective cleaning are not visually confirmed on either the print sheet or the image bearer, but streak-like toner slippage is confirmed when the image bearer is observed with a microscope in the longitudinal direction.

C: Toner particles having slipped through due to defective cleaning are visually confirmed on either the print sheet or the image bearer.

TABLE 1

| | | Examples | | | | | | | | Comparative examples | | |
|---|---|---|---|---|---|---|---|---|---|---|---|---|
| | | 1 | 2 | 3 | 4 | 5 | 6 | 7 | 8 | 1 | 2 | 3 |
| Particle dispersion used for | | A | E | B | C | A | B | A | D | — | C | B |
| forming coating layer | | | | | | | | | | | | |
| Particles | PTFE (particle diameter: | 3.4 | — | 3.55 | 6.8 | 3.4 | 3.55 | 3.4 | — | — | 6.8 | 3.55 |
| | 0.200 [μm]) | | | | | | | | | | | |
| | PTFE (particle diameter: | 3.4 | — | 3.3 | — | 3.4 | 3.3 | 3.4 | — | | — | 3.3 |
| | 0.120 [μm]) | | | | | | | | | | | |
| | PMMA (particle | — | 95.0 | — | — | — | — | — | 97.0 | — | — | — |
| | diameter: 0.150 [μm]) | | | | | | | | | | | |
| Binder | VdF/HFP/TFE | 0.2 | — | 0.15 | 0.2 | 0.2 | 0.15 | 0.2 | — | — | 0.2 | 0.15 |
| resin | Polyvinyl butyral | — | — | — | — | — | — | — | 3.0 | — | — | — |
| | Polyvinyl alcohol | — | 5.0 | — | — | — | — | — | — | — | — | — |
| Dispersion | 1,1,2,2-tetrafluoroethyl | 93.0 | — | 93.0 | 93.0 | 93.0 | 93.0 | 93.0 | — | — | 93.0 | 93.0 |
| solvent | 2,2,2-trifluoroethyl ether | | | | | | | | | | | |

| | | | | | | | | | | | |
|---|---|---|---|---|---|---|---|---|---|---|---|
| Average thickness [μm] | 0.5 | 2.0 | 8.0 | 12.0 | 3.5 | 4.0 | 4.5 | 7.0 | — | 0.4 | 2.0 |
| Martens hardness [N/mm²] in base | 1.1 | 1.4 | 0.9 | 2.0 | 0.5 | 0.7 | 0.5 | 0.8 | 2.0 | 0.5 | 0.7 |
| layer | | | | | | | | | | | |
| Developed Interfacial area ratio | 1.2 | 1.2 | 1.3 | 1.3 | 1.4 | 1.6 | 1.7 | 1.8 | 0.1 | 1.1 | 1.9 |
| Sdr [%] | | | | | | | | | | | |
| Torque increase rate | B | B | B | A | A | A | A | B | C | C | C |
| Cleaning performance | B | B | B | B | A | A | A | A | B | C | B |

Aspects of the present disclosure are, for example, as follows.

### <First Aspect>

In a first aspect, a cleaning blade is in contact with a surface of a cleaning target to remove a residue on the surface of the cleaning target. The cleaning blade has the following features.

The cleaning blade includes the cleaning blade substrate including an elastic body and the cleaning blade support supporting the cleaning blade substrate. The elastic body includes a coating layer on a tip portion that contacts the cleaning target. The coating layer on a cleaning face of the cleaning blade substrate has a developed interfacial area ratio Sdr of 1.2% or more and 1.8% or less in a 100 μm square region inward from a tip ridge of the coating layer.

### <Second Aspect>

In a second aspect, the cleaning blade according to the first aspect includes the coating layer having a developed interfacial area ratio Sdr of 1.4% or more and 1.7% or less in the 100 μm square region inward from the tip ridge of the coating layer on the cleaning face of the cleaning blade substrate.

### <Third Aspect>

In a third aspect, the cleaning blade according to the first aspect or the second aspect includes the coating layer on the cleaning face of the cleaning substrate, and the coating layer has a thickness of 0.5 μm or more and 12 μm or less at a position 100 μm inward from a tip ridge of the cleaning blade.

### <Fourth Aspect>

In a fourth aspect, the cleaning blade according to any one of the first to third aspects includes the coating layer including particles and binder resin.

<Fifth Aspect>In a fifth aspect, the cleaning blade according to any one of the first to fourth aspects includes the coating layer including multiple particles having different particle diameters.

### <Sixth Aspect>

In a sixth aspect, the cleaning blade according to the fourth aspect includes the coating layer including at least one of a coating film having the particles made of polytetrafluoroethylene and the binder resin made of fluorine-based resin and a coating film having the particles made of acrylic and the binder resin made of polyvinyl alcohol resin or polyvinyl acetal resin.

### <Seventh Aspect>

In a seventh aspect, the cleaning blade according to any one of the first to sixth aspects includes the cleaning blade substrate having one of a single-layer structure of polyurethane rubber and a laminated structure on which polyurethane rubbers are laminated to form layers having different Martens hardnesses.

### <Eighth Aspect>

In an eighth aspect, the cleaning blade according to the seventh aspect includes the cleaning blade substrate having the single-layer structure of polyurethane rubber and a Martens hardness of 0.5 [N/mm²] or more and 2 [N/mm²] or less.

### <Ninth Aspect>

In a ninth aspect, a process cartridge includes: an image bearer; at least one of a charger to charge a surface of the image bearer, an irradiator to irradiate the charged surface of the image bearer to form an electrostatic latent image, a developing device to develop the electrostatic latent image into a toner image, and a transferor to transfer the toner image onto a recording medium; and a cleaner to contact the surface of the image bearer to remove a residue on the surface of the image bearer, and the cleaner includes the cleaning blade according to any one of the first to eighth aspects.

### <Tenth Aspect>

In a tenth aspect, an image forming apparatus includes: an image bearer, a charger to charge a surface of the image bearer, an irradiator to irradiate the charged surface of the image bearer to form an electrostatic latent image, a developing device to develop the electrostatic latent image into a toner image, a transferor to transfer the toner image onto a recording medium, a fixing device to fix the toner image transferred to the recording medium, and a cleaner to contact the surface of the image bearer to remove a residue on the surface of the image bearer, and the cleaner includes the cleaning blade according to any one of the first to eighth aspects.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A cleaning blade comprising:
a blade substrate including an elastic body having a tip portion to be in contact with a surface of an object to clean the surface of the object;
a blade support supporting the blade substrate; and
a coating layer coating at least the tip portion of the elastic body to form a tip ridge in contact with the surface of the object,
the coating layer having a developed interfacial area ratio (Sdr) of 1.2% or more and 1.8% or less in a 100 μm square region inward from the tip ridge of the coating layer on the blade substrate.

2. The cleaning blade according to claim 1,
wherein the developed interfacial area ratio (Sdr) is 1.4% or more and 1.7% or less.

3. The cleaning blade according to claim 1, wherein the coating layer has a thickness of 0.5 μm or more and 12 μm or less at a position 100 μm inward from the tip ridge.

4. The cleaning blade according to claim 1,
wherein the coating layer includes particles and binder resin.

5. The cleaning blade according to claim 1,
wherein the coating layer includes multiple particles having different particle diameters.

6. The cleaning blade according to claim 4,
wherein the coating layer includes:
a coating film including:
the particles made of polytetrafluoroethylene; and
the binder resin made of fluorine-based resin; or
a coating film including:
the particles made of acrylic resin; and
the binder resin made of polyvinyl alcohol resin or polyvinyl acetal resin.

7. The cleaning blade according to claim 1,
wherein the blade substrate has one of:
a single-layer structure of polyurethane rubber; and
a laminated structure including multiple layers of polyurethane rubber, and the multiple layers have different Martens hardnesses.

8. The cleaning blade according to claim 7,
wherein the blade substrate has:
the single-layer structure of polyurethane rubber; and
a Martens hardness of 5.0 N/mm² or more and 30.0 N/mm² or less.

9. A process cartridge comprising:
an image bearer;
at least one of
a charger to charge a surface of the image bearer,
an irradiator to irradiate the surface of the image bearer with light to form an electrostatic latent image,
a developing device to develop the electrostatic latent image and form a toner image, and
a transferor to transfer the toner image onto a recording medium; and
the cleaning blade according to claim 1 contacting the surface of the image bearer to remove residue on the surface of the image bearer.

10. An image forming apparatus comprising:
an image bearer;
a charger to charge a surface of the image bearer;
an irradiator to irradiate the surface of the image bearer with light to form an electrostatic latent image;
a developing device to develop the electrostatic latent image and form a toner image;
a transferor to transfer the toner image onto a recording medium;
a fixing device to fix the toner image transferred onto the recording medium; and
the cleaning blade according to claim 1 contacting the surface of the image bearer to remove residue on the surface of the image bearer.
